(19) United States
(12) Patent Application Publication
(10) Pub. No.: US 2004/0189007 A1
(43) Pub. Date: Sep. 30, 2004

(54) Quick operation bottom sealing connectors for flexible tubing and flared tubing

(76) Inventor: Jack M. Olich, Mahopac, NY (US)

Correspondence Address: LAWRENCE CRUZ, 12 GOOD HILL RD., BETHEL, CT, 06801, US

(21) Appl. No.: 10/814,720

(22) Filed: Mar. 31, 2004

Related U.S. Application Data
(60) Provisional application No. 60/458,807, filed on Mar. 31, 2003.

(51) Int. Cl. F16L 55/00

(52) U.S. Cl. 285/353

(57) ABSTRACT

A flexible or flared tube connecting devices for handling gas or fluids has a threaded or snap-fit components for quickly attaching and detaching a coupling while achieving an effective seal that is not prone to leaking or breakdown due to weak sealing force or over-tightening of coupling components with resultant over-stressing of seal components. A spring applies compression force to a sealing body whereby the force applied from the spring is the sole source of compression force and is not susceptible to distortion due to over-tightening of the coupling.

### RELATED APPLICATIONS

This application is based on and claims priority from earlier filed U.S. Provisional Application 60/458,807 filed on 31 Mar. 2003.

### TECHNICAL FIELD

The present invention relates to tubing connectors and, more particularly, to quick-operating, sealing connectors for use with flexible and flared tubing.

### BACKGROUND OF THE INVENTION

Certain technical applications require connection of fluid or gas conduits made of flexible tubing in a manner in which sealing is achieved with minimal dead (unswept) volume and carryover phenomena. Such applications may include, but are not limited to, wet chemistry analytical instruments, medical or laboratory diagnostic or testing assemblies, and waste handling systems. In such applications it is desirable to have connectors that can be engaged or disengaged quickly, that can reliably form a seal, and that can be made in a cost effective manner such that they are disposable. Additional desirable qualities for such connectors include ease-of-use to ensure that tubing assemblies are put together correctly and in a manner that there is no danger of leaking or breakdown.

It is, therefore, an object of the present invention to provide a device for quickly connecting flexible or flared tubing that reliably forms a seal in a manner that is easy to use.

It is a further object of the present invention to provide a device for connecting tubing that is also economical to make and that is easily disposed of

It is a further object of the present invention to provide a device for connecting tubing that minimizes dead volume and carryover phenomena.

It is a further object of the present invention to provide a device for connecting tubing that provides a visual indication that confirms when a proper connection has been made and that is configured to be connected only in one way to ensure that improper connections are not inadvertently made.

It is a further object of the present invention to provide a device or connecting tubing that employs a bottom-sealing technique.

These and other objects are achieved by the present invention described herein.

### SUMMARY OF THE INVENTION

The present invention is directed to various embodiments of flexible or flared tube connecting devices for handling gas or fluids. Common to each embodiment is a combination of novel means for quickly attaching and detaching a coupling while achieving an effective seal that is not prone to leaking or breakdown due to weak sealing force or over-tightening of coupling components with resultant over-stressing of seal components. Each embodiment comprises a spring for applying compression force to a sealing body whereby the force applied from the spring is the sole source of compression force and is not susceptible to distortion due to over-tightening of the coupling. The various novel couplings disclosed include threaded and snap-fit components designed to achieve quick and accurate connects and disconnects when a coupling body carrying a tube-holder is positioned adjacent to a port having a fluid conduit that is placed in communication with a tube carried by the tube-holder.

### BRIEF DESCRIPTION OF THE DRAWINGS

FIGS. 1A and 1B are sectional, side views of a first embodiment coupling and sealing device according to the present invention shown in un-connected and connected modes, respectively.

FIGS. 2A and 2B are sectional, side views of a second embodiment coupling and sealing device according to the present invention shown in un-connected and connected modes, respectively.

FIGS. 3A and 3B are sectional, side views of a third embodiment coupling and sealing device according to the present invention shown in un-connected and connected modes, respectively.

FIGS. 4A and 4B are sectional, side views of a fourth embodiment coupling and sealing device according to the present invention shown in un-connected and connected modes, respectively.

FIGS. 5A and 5B are sectional, side views of a fifth embodiment coupling and sealing device according to the present invention shown in un-connected and connected modes, respectively.

FIGS. 6A and 6B are sectional, side views of a sixth embodiment coupling and sealing device according to the present invention shown in un-connected and connected modes, respectively.

### DESCRIPTION OF THE PREFERRED EMBODIMENTS

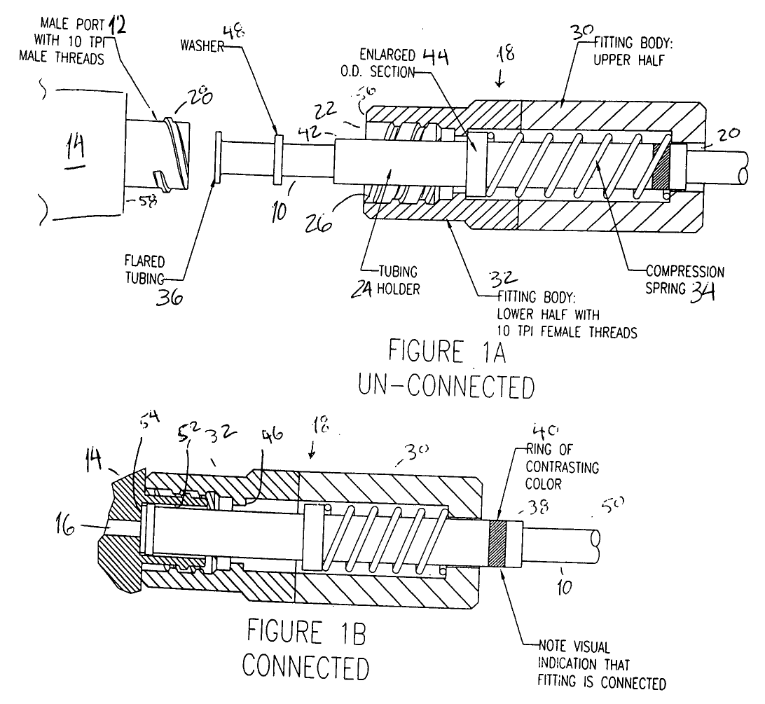

A first embodiment of the present invention for joining a flexible tube (10) to a male port (12) of a body (14) having a fluid passage (16), shown in FIG. 1A and FIG. 1B, comprises a fitting body (18) which includes a first opening (20) at one end and a second opening (22) at the opposite end. The first opening (20) is configured to permit relative sliding therethrough of a tubing holder (24). The opening (20) and tubing holder (24) may be round in cross-section, as shown, or of another desired shape. The second opening (22) is wide enough to matingly receive the outer diameter of a connecting portion of the male port (12). The second opening (22) has internal threads (26) that mate with external threads (28) on the outer diameter of the connecting portion of the male port (12). The fitting body (18) may be a unitary body or it may be made of a first body section (30) joined to a second body section (32), as shown, for ease of assembly. The body (18) and its sections (30, 32) may be made from any of a variety of known materials including plastics, and the sections (30, 32) may be joined by snap-fit connection, screws, ultrasonic welding, or other suitable means,

Housed internally to the fitting body (18), are the tubing holder (24) and compression spring (34). The tubing holder (24) is a tube-shaped sleeve having an inside diameter of sufficient size to fit around the flexible tube (10) to be connected, but of small enough size to prevent a flared end (36) of the flexible tube (10) from passing through. A first end (38) of the tubing holder (24), which is open to allow the flexible tube (10) to extend out, has external markings in the form of a ring of contrasting color (40). A second end (42) of the tubing holder (24) is also open to allow the flexible tube (10) to extend out. The tubing holder (24) has an enlarged outside diameter section (44) between the first and second ends (38, 42), which serves as a seat for the compression spring (34) on one side, and as a stop which abuts an internal shoulder (46) of the fitting body (18). The compression spring (34) is seated at a first end against the inner surface (48) of an end wall forming the first opening (20) of the fitting body (18). The compression spring (34) is seated at its opposite end against the internal shoulder (46). While the preferred embodiment discloses a coil spring, various other types of known, resilient compression members may be utilized.

In use, a flexible tube (10) to be connected to a body (14) having a fluid passage (16) is passed through a flexible washer (48) and through the tubing holder (24). The tube (10) may be passed flared end (36) first before the flare is formed, or opposite end (50) first after the flare is formed. The tubing holder (24) is pre-positioned in the fitting body (18) prior to placement of the tube (10) therein.

As shown in FIG. 1A, in a disconnected position, the flared end (36) of the flexible tube (10) extends past the second end (42) of the tubing holder (24). The compression spring (34) biases the tubing holder (24) in a direction away from the first opening (20) such that the enlarged outside diameter section (44) abuts the internal shoulder (46).

Now referring to FIG. 1B, to complete the connection of the tube (10) to the body (14), the flared tubing end (36), the washer (48), and a portion of the tubing holder (24) are placed inside an opening (52) of the male port (12). The tubing holder (24) is advanced into the opening until it abuts against the washer (48) which abuts the flared end (36) that is in contact on its other side with a seat portion (54) on the inside of the male port opening (52). As shown in FIG. 1B, the tube (10) and the washer (48) have slid relative to the tubing holder (24) relative to their positions shown in FIG. 1A.

Once the flared end (36) is in abutment with the seat portion (54), the fitting body (18) is advanced toward the body (14), while overcoming the opposing force created by the compression spring (34). The internal threads (26) of the fitting body (18) are engaged with the external threads (28) until the fitting body (18) is seated as shown in FIG. 1B. The threads (26, 28) are rotatably engaged, as the fitting body (18) is rotated relative the body (14). Once the fitting body (18) is seated, the connection is complete. The compression force of the compression spring (34) is transmitted through the washer (48) and the flared end (36) to the seat portion (54). Because one or both of the flared end (36) and washer (48) are made of flexible or compressible material, a pressure-tight seal is formed between the flexible tube (10) and the seat portion (54), thereby placing the fluid passage (16) in sealed, fluid communication with the flexible tube (10). Alternatively, use of the washer (48) may be eliminated depending on the size, shape, and material properties of the flared end (36). The continuous application of compressive force from the compression spring (34) maintains the washer (48) and flared end (36) in a mechanically energized, seal-forming state. The threads (26, 28) are configured to enable the fitting body (18) to be fully seated such that the abutment end (56) of the fitting body (18) abut the face (58) of the body (14). Since the fitting body (18) fully seats and the compressive force delivered to the washer (48) and flared end (36) essentially depends on the compression spring (34), the danger of over-tightening the threads and resultantly over-compressing the flared end (36) that exists in prior art devices does not exist in the present invention. In order to provide a visual indication that the connection is complete, a ring of contrasting color (40) is provided to the end of the tubing holder (24) which extends out from the fitting body (18) only in the closed condition shown in FIG. 1B.

The connection may be disconnected by reversing rotation of the fitting body (18) to un-thread the threads (26, 28) of the fitting body (18) and the male port (12).

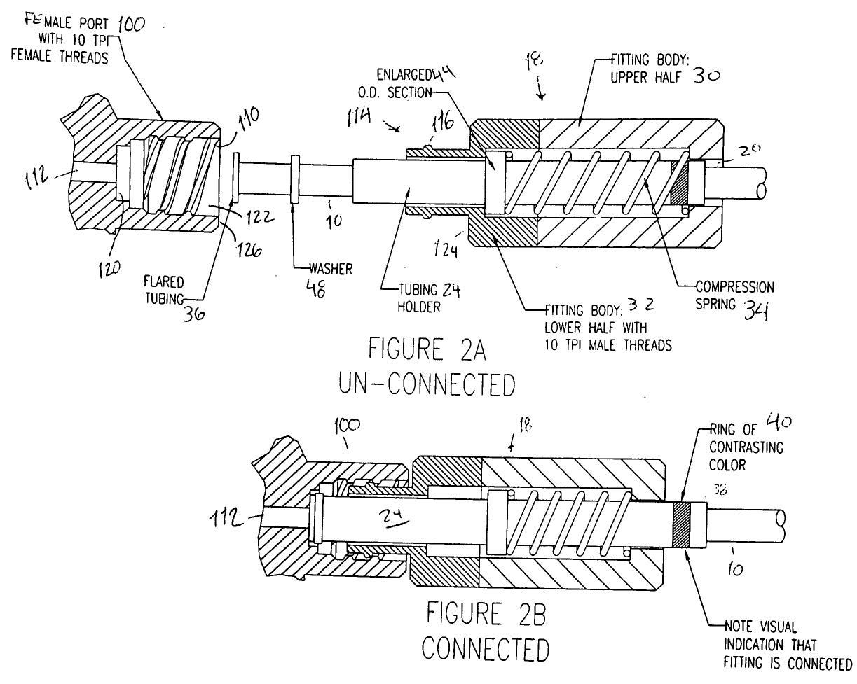

Another preferred embodiment of the present invention is described with respect to FIG. 2A and FIG. 2B. To the extent that the components of this embodiment are the same in design and function as components shown in the previous embodiment, they are numbered with the same reference numerals and their textual description is found in the description of the previous embodiment. With regard to components that are unique to this embodiment in design or function, their reference numerals are unique to FIG. 2A and FIG. 2B and their description is now set forth.

Referring to FIG. 2A and FIG. 2B, the fitting body (18) has a port-engaging section (114) that is shaped and sized the be received in a female port (100). The female port (100) has a fluid passage (112), a seat (120) and internal threads (110). The port-engaging section (114) has a thread (116) which engages the internal threads (110) when the fitting body (18) is engaged with the female port (100) in the connected position shown in FIG. 2B.

In operation, to complete the connection of the tube (10) to the female port (100), the flared tubing end (36), the washer (48), and a portion of the tubing holder (24) are placed inside an opening (122) of the female port (100). The tubing holder (24) is advanced into the opening either prior to or until the shoulder (124) of the fitting body (18) abuts against the end face (126) of the female port (100). It is not necessary to advance the fitting body (18) until the shoulder (124) abuts the end face (126) as long as the threads (110, 116) form a secure connection. As shown in FIG. 2B, the tube (10) and the washer (48) have slid relative to the tubing holder (24) relative to their positions shown in FIG. 2A.

Once the flared end (36) is in abutment with the seat (120), the fitting body (18) is advanced toward the female port (100), while overcoming the opposing force created by the compression spring (34). The threads (110, 116) are rotatably engaged, as the fitting body (18) is rotated relative the female port (100). Once the connection is complete, the compression force of the compression spring (34) is transmitted through the washer (48) and the flared end (36) to the seat (120). Because one or both of the flared end (36) and washer (48) are made of flexible or compressible material, a pressure-tight seal is formed between the flexible tube (10) and the seat (120), thereby placing the fluid passage (112) in sealed, fluid communication with the flexible tube (10). Alternatively, use of the washer (48) may be eliminated depending on the size, shape, and material properties of the flared end (36). The continuous application of compressive force from the compression spring (34) maintains the washer (48) and flared end (36) in a mechanically energized, seal-forming state. The threads (110, 116) are configured to enable the fitting body (18) to be fully seated such that the compressive force delivered to the washer (48) and flared end (36) essentially depends on the compression spring (34), and the danger of over-tightening the threads and resultantly over-compressing the flared end (36) that exists in prior art devices does not exist in the present invention. In order to provide a visual indication that the connection is complete, a ring of contrasting color (40) is provided to the end of the tubing holder (24) which extends out from the fitting body (18) only in the closed condition shown in FIG. 2B.

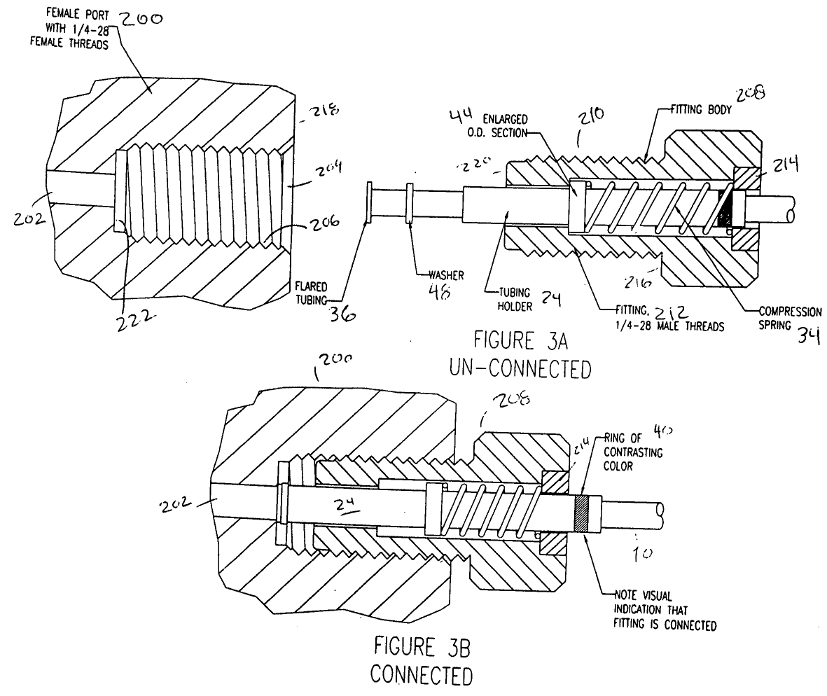

The connection may be disconnected by reversing rotation of the fitting body (18) to un-thread the threads (110, 116) of the fitting body (18) and the female port (100). Another preferred embodiment of the present invention is described with respect to FIG. 3A and FIG. 3B. To the extent that the components of this embodiment are the same in design and function as components shown in the previous embodiments, they are numbered with the same reference numerals and their textual description is found in the description of the previous embodiments. With regard to components that are unique to this embodiment in design or function, their reference numerals are unique to FIG. 3A and FIG. 3B and their description is now set forth.

Referring to FIG. 3A and FIG. 3B, the fitting body (208) is a unitary body and has a port-engaging section (210) that is shaped and sized the be received in a female port (200). The female port (200) has a fluid passage (202), a seat (222) and internal threads (206). The port-engaging section (210) has threads (212) which engages the internal threads (206) when the fitting body (208) is engaged with the female port (200) in the connected position shown in FIG. 3B.

In operation, to complete the connection of the tube (10) to the female port (200), the flared tubing end (36), the washer (48), and a portion of the tubing holder (24) are placed inside an opening (204) of the female port (200). The tubing holder (24) is advanced into the opening, though not necessarily until the shoulder (216) of the fitting body (208) abuts against the end face (218) of the female port (200). It is not necessary to advance the fitting body (208) until the end face (220) abuts the seat (222) as long as the threads (206,212) form a secure connection. As shown in FIG. 3B, the tube (10) and the washer (48) have slid relative to the tubing holder (24) relative to their positions shown in FIG. 3A.

Once the flared end (36) is in abutment with the seat (222), the fitting body (208) is advanced toward the female port (200), while overcoming the opposing force created by the compression spring (34). The threads (206,212) are rotatably engaged, as the fitting body (208) is rotated relative the the female port (200). Once the connection is complete, the compression force of the compression spring (34) is transmitted through the washer (48) and the flared end (36) to the seat (222). Because one or both of the flared end (36) and washer (48) are made of flexible or compressible material, a pressure-tight seal is formed between the flexible tube (10) and the seat (222), thereby placing the fluid passage (202) in sealed, fluid communication with the flexible tube (10). Alternatively, use of the washer (48) may be eliminated depending on the size, shape, and material properties of the flared end (36). The continuous application of compressive force from the compression spring (34) maintains the washer (48) and flared end (36) in a mechanically energized, seal-forming state. The threads (206, 212) are configured to enable the fitting body (208) to be fully seated such that the compressive force delivered to the washer (48) and flared end (36) essentially depends on the compression spring (34), and the danger of over-tightening the threads and resultantly over-compressing the flared end (36) that exists in prior art devices does not exist in the present invention. In order to provide a visual indication that the connection is complete, a ring of contrasting color (40) is provided to the end of the tubing holder (24) which extends out from the fitting body (18) only in the closed condition shown in FIG. 3B.

The connection may be disconnected by reversing rotation of the fitting body (18) to un-thread the threads (206, 212) of the fitting body (18) and the female port (200).

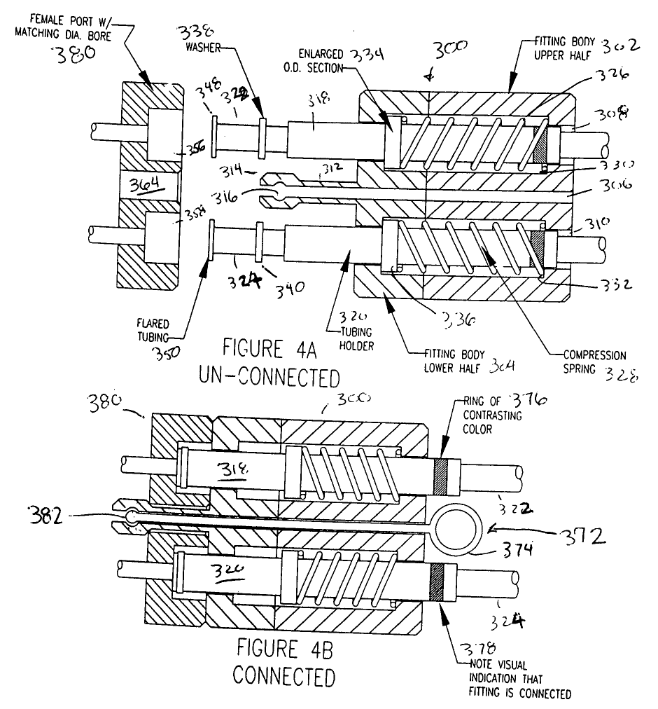

Another embodiment, shown in FIG. 4A and FIG. 4B, is directed to a fitting body (300) that may be unitary or that may comprise a first section (302) and a second section (304). The fitting body (300) includes a central passage (306) extending therethrough, as well as first and second tube passages (308, 310) passing therethrough. The fitting body (300) further includes an extension (312) having an enlarged end (314) and an internal detent (316). A first tubing holder (318) and a second tubing holder (320), each being tube-shaped sleeves, are positioned in the first and second tube passages (308, 310), respectively. A first tube (322) and a second tube (324) are received, respectively, in the first and second tubing holders (318, 320). First and second compression springs (326, 328) each surround a respective one of the first and second tubing holders (318, 320) and are seated at one end on shoulders (330, 332) of the tube passages (308, 310), and at the other end on an enlarged outside diameter portion (334, 336) of each respective tubing holder (318, 320).

In use, the first and second tubes (322, 324) are positioned through a respective one of the tubing holders (318, 320). The flared ends (348, 350) of the tubes (322, 324), along with washers (338, 340) positioned around each, are positioned within openings (356, 358) of a dual female port (380). The fitting body (300) is advanced toward the female port (380), as the extension (312) and its enlarged end (314) are passed through a central opening (364) of the female port (380). A locking rod (372) having a ball-shaped end (382) opposite of a ring (374) is positioned through the central passage (306) of the fitting body (300) until the ball end (382) rests in the detent (316), thereby holding the enlarged end (14) in an expanded state making it impossible to pass back through the central opening (364). The locking rod (372), thus, maintains the fitting body (300) in a close, fixed relationship to the female port (380) such that the tubes (322, 324) are placed in fluid communication with the fluid passages (352, 354) when the flared ends (348, 350) and washers (338, 340) are pressed against a respective one of the seats (362, 366). In this position, the end faces (368, 370) of the fitting body (300) abut the end face (384) of the female port (380). The only force acting on the flared tubing ends (348, 350) and pressing them into sealing engagement with the seats (362, 366) is that from each of the springs (326, 328), respectively, which transmit force through the enlarged outside diameter portions (334, 336) and tubing holders (318, 320), and the washers (338, 340), to the flared ends (348, 350). The washers (338, 340) may or may not be used depending on the characteristics and desired sealing qualities of the flared ends (348, 350). Note that in this position, shown in FIG. 3B, the tubing holders (318, 320) are caused to move in a manner that exposes visual indicators (376, 378) to indicate a connected condition wherein the tubes (322, 324) are placed in sealed, locked fluid communication with the fluid passages (352, 354). To disconnect, the ring (374) of the locking rod (372) is pulled away from the female port (380) to release the detent ball (382) from the detent portion (316), allowing the extension (312) to be withdrawn from the central opening (364), thereby allowing the fitting body (300) and tubes (322, 324) to be pulled away from the female port (380).

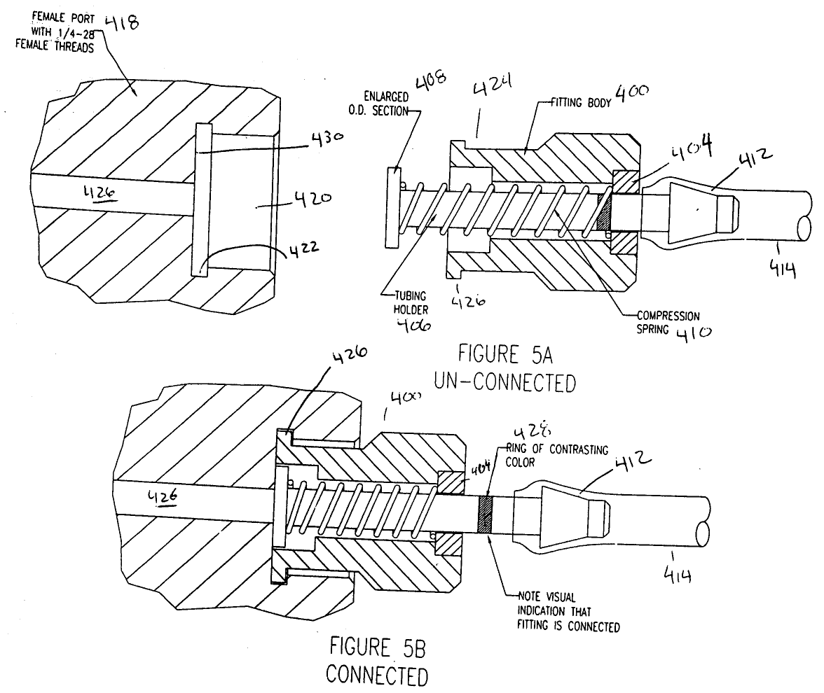

Another preferred embodiment of the present invention is described with respect to FIG. 5A and FIG. 5B.

Referring to FIG. 5A and FIG. 5B, the fitting body (400) has a port-engaging section (424) that is shaped and sized the be received in a female port (418). The female port (418) has a fluid passage (426), a seat (430) and an internal, expanded diameter ring (422). The port-engaging section (424) has a flange (426) which engages the internal ring (422) when the fitting body (400) is engaged with the female port (418) in the connected position shown in FIG. 5B.

In operation, to complete the connection of the tube (414) to the female port (418), the enlarged outside diameter section (408) is placed inside the opening (420) of the female port (418) and in abutment with the seat (430). The tubing holder (24), which is tube-shaped and has a fluid passage therethrough, is advanced into the opening (420) until the flange (426) of the fitting body (400) is snap-fitted into the ring (422). Preferable, the flange (426) is flexible and may be press-fit into the ring (422). Alternatively, the flange and opening of the female port may be configured for a bayonet-type connection (not shown).

Once the fitting body (400) is attached to the female port (418), the compression spring (410), which is seated between the end cap (404) of the fitting body (400) and the enlarged outside diameter section (408) of the tubing holder (406), maintains the tubing holder (406) in sealed communication with the fluid passage (426) and the tube (414) which is attached to the tubing holder (406) by being fitted over a barb-type end (412). In order to provide a visual indication that the connection is complete, a ring of contrasting color (428) is provided to the end of the tubing holder (406) which extends out from the fitting body (400) only in the closed condition shown in FIG. 5B.

The connection may be disconnected by un-snapping the flange (426) from the inner ring (422) and withdrawing the fitting body (400) away from the female port (418).

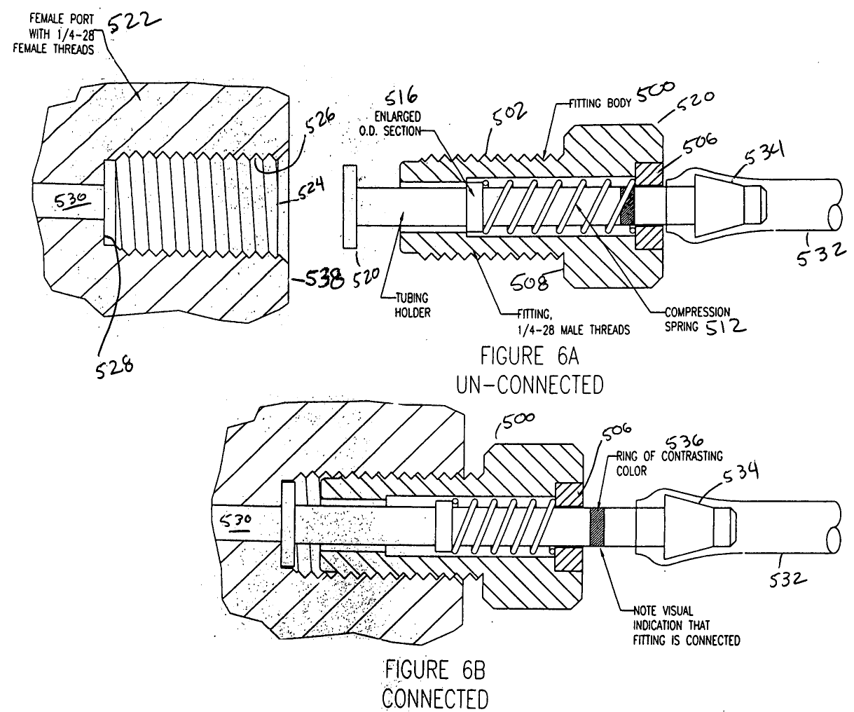

A final preferred embodiment of the present invention is described with respect to FIG. 6A and FIG. 6B.

Referring to FIG. 6A and FIG. 6B, the fitting body (500) is shaped and sized the be received in a female port (522). The female port (522) has a fluid passage (530), a seat (528) and internal threads (526). The fitting body (500) has threads (502) which engage the internal threads (526) when the fitting body (500) is engaged with the female port (522) in the connected position shown in FIG. 6B.

In operation, to complete the connection of the tube (532) to the female port (522), the enlarged outside diameter end (520) of the tubing holder (518) and a portion of the fitting body (518) are placed inside the opening (524) of the female port (522). The tubing holder (518) is tube-shaped and has a fluid passage therethrough, and its enlarged end (520) is advanced into the opening until it contacts the seat (528). The fitting body (500) is advanced into and held in the opening (524) by engagement and relative rotation of the threads (502, 526) of the fitting body (500) and female port (522), respectively. It is not necessary to advance the fitting body (522) until the shoulder (508) abuts the end face (538) as long as the threads (502, 526) form a secure connection.

Once the connection is complete, the compression force of the compression spring (512), which is seated between the end cap (506) and an intermediate enlarged outside diameter portion (516), is transmitted through the tubing holder (518) and the enlarged end (520) to the seat (528). A pressure-tight seal is formed between the tubing holder (518) and the seat (528), thereby placing the fluid passage (530) in sealed, fluid communication with the flexible tube (532), which is attached to and in fluid communication with the tubing holder (518) by a barb-shaped connector (534). In order to provide a visual indication that the connection is complete, a ring of contrasting color (536) is provided to the end of the tubing holder (518) which extends out from the fitting body (500) only in the closed condition shown in FIG. 6B.

The connection may be disconnected by reversing rotation of the fitting body (500) to un-thread the threads (502, 526) of the fitting body (500) and the female port (522).

While the preferred embodiments of the present invention have been herein shown and described, it is understood that various modification may be made without departing from the scope of the presently claimed invention.

What is claimed is:

1. A connector system for sealingly connecting a tube to a fluid passage, said system comprising
a first body forming a housing with a first end and a second end, and an internal chamber connecting said first and second ends;
a sleeve slidably received in said chamber, said sleeve having a first end and a second end and said sleeve being adapted to receive said tube to be connected;
a spring positioned between said first body and said sleeve such that relative movement between said first body and said sleeve causes said spring to be energized;
a second body having a first end with a first opening in fluid communication with said fluid passage, a second end having a second opening, and an internal chamber in fluid communication with said first and second openings; and
interconnecting elements formed on each of said first body and said second body in order to selectively connect and disconnect said first and second bodies in a manner in which, in a connected state, said spring biases said tube against said second body to form a sealed fluid communication between said tube and said passage.

2. A system according to claim 1, further comprising
a visual indicating member distinguishing a connected position from a disconnected position.

3. A system according to claim 1, wherein
said sleeve includes a flange for seating a first end of said spring, and said housing includes an internal shoulder for seating another end of said spring, whereby relative movement of said sleeve toward said shoulder causes said spring to undergo compression and produce a biasing force therebetween.

4. A system according to claim 1, wherein
said interconnecting elements comprise a threaded female connection end on said first body and a threaded male connection end on said second body.

5. A system according to claim 1, wherein
said interconnecting elements comprise a threaded male connection end on said first body and a threaded female connection end on said second body.

6. A system according to claim 2, wherein
said visual indicating member comprises a mark on said sleeve that is visible when said first and second bodies are connected.

7. A connector system for sealingly connecting a plurality of tubes to a plurality of fluid passages, said system comprising
a plurality of primary bodies, each forming a housing with a first end and a second end, and each having an internal chamber connecting said first and second ends;
a plurality of sleeves, each slidably received in a corresponding one of said chambers, each said sleeve having a first end and a second end and each said sleeve being adapted to receive one of said tubes to be connected;
a plurality of springs, each positioned between one of said first bodies and a corresponding one of said sleeves such that relative movement between said first body and said sleeve causes said spring to be energized;
a plurality of second bodies, each having a first end with a first opening in fluid communication with a corresponding one of said fluid passages, a second end having a second opening, and an internal chamber in fluid communication with corresponding ones of said first and second openings; and
interconnecting elements formed on at least one of said first body and said second body in order to selectively connect and disconnect said first and second bodies in a manner in which, in a connected state, said spring biases said tube against said second body to form a sealed fluid communication between said tube and said passage.

8. A system according to claim 8, wherein
said interconnecting elements comprise an expanding lock member having a removable key-like member adapted to selectively lock and release said interconnecting elements.

9. A system according to claim 1, wherein
said interconnecting member comprise a flange and a groove for selectively receiving said flange.

10. A connector system for sealingly connecting a tube to a fluid passage, said system comprising
a first body forming a housing with a first end and a second end, and an internal chamber connecting said first and second ends;
a sleeve slidably received in said chamber, said sleeve having a first end and a second end and said sleeve first end being adapted to attach to said tube to be connected such that said tube is in fluid communication with said sleeve;
a spring positioned between said first body and said sleeve such that relative movement between said first body and said sleeve causes said spring to be energized;
a second body having a first end with a first opening in fluid communication with said fluid passage, a second end having a second opening, and an internal chamber in fluid communication with said first and second openings; and
interconnecting elements formed on each of said first body and said second body in order to selectively connect and disconnect said first and second bodies in a manner in which, in a connected state, said spring biases said sleeve against said second body to form a sealed fluid communication between said tube, said sleeve, and said passage.
